(19) United States
(12) Patent Application Publication
(10) Pub. No.: US 2003/0222530 A1
(43) Pub. Date: Dec. 4, 2003

(54) Horizontal-axis electrical machine

(76) Inventors: Daniel Hediger, Othmarsingen (CH); Gianfranco Guerra, Birr (CH); Martin Rieder, Brugg (CH)

Correspondence Address: BURNS, DOANE, SWECKER & MATHIS, L.L.P., P.O. Box 1404, Alexandria, VA, 22313-1404, US

(21) Appl. No.: 10/388,661

(22) Filed: Mar. 17, 2003

Related U.S. Application Data
(63) Continuation of application No. 09/643,679, filed on Aug. 24, 2000, now abandoned.

(30) Foreign Application Priority Data
Aug. 27, 1999 (DE) 199 40 630.8

(51) Int. Cl. H02K 1/06

(52) U.S. Cl. 310/217

(57) ABSTRACT

A horizontal-axis electrical machine (10) comprises a casing (14, 15, 16), which is reinforced by casing ribs (24, . . . , 27, 30) and is subdivided into a bottom casing section (15) and a removable top casing section (16), and comprises a laminated stator core (11), which is braced in bearing rings (13, 13′, 13″), which are arranged perpendicular to the longitudinal axis (36) of the machine and are spaced apart from one another, the bearing rings (13, 13′, 13″) being resiliently connected at a plurality of points of their outer circumference to the bottom casing section (15) by means of fastening parts (18, 19, 20, 21).

In the case of such a machine (10), transport securement that does not hinder later operation is achieved by providing that between the laminated stator core (11) or the bearing rings (13, 13′, 13″) and the bottom casing section (15) there are arranged fixedly adjusted securing means (31, . . . , 35), which during transportation of the machine (10) limit the axial relative movement between the laminated stator core (11) or the bearing rings (13, 13′, 13″) and the bottom casing section (15), and during operation ensure a free expansion of the warmer laminated stator core (11) with respect to the colder casing (14, 15, 16).

The present invention relates to the field of electrical machines. It concerns a horizontal-axis electrical machine according to the preamble of claim 1.

Such a machine is known, for example, from the applicant's EP-A2-0 633 643.

In the case of gas-cooled electrical machines, such as turbogenerators for example, the operationally related heating causes great axial and radial expansions to occur in the laminated stator core, in particular in relatively high output ranges, and these expansions have to be transferred as uniformly as possible to the casing surrounding the laminated stator core. It has already been proposed in this respect in U.S. Pat. No. 4,663,553 to wedge the laminated stator core in a multiplicity of bearing rings which are perpendicular to the longitudinal axis of the machine, spaced apart from one another and securely welded on opposite sides to the bottom casing section by means of vertical fastening plates and horizontal pieces of tube. This type of fastening allows simple assembly and easy accessibility of the structural parts to be welded and, furthermore, ensures good quality of the welds.

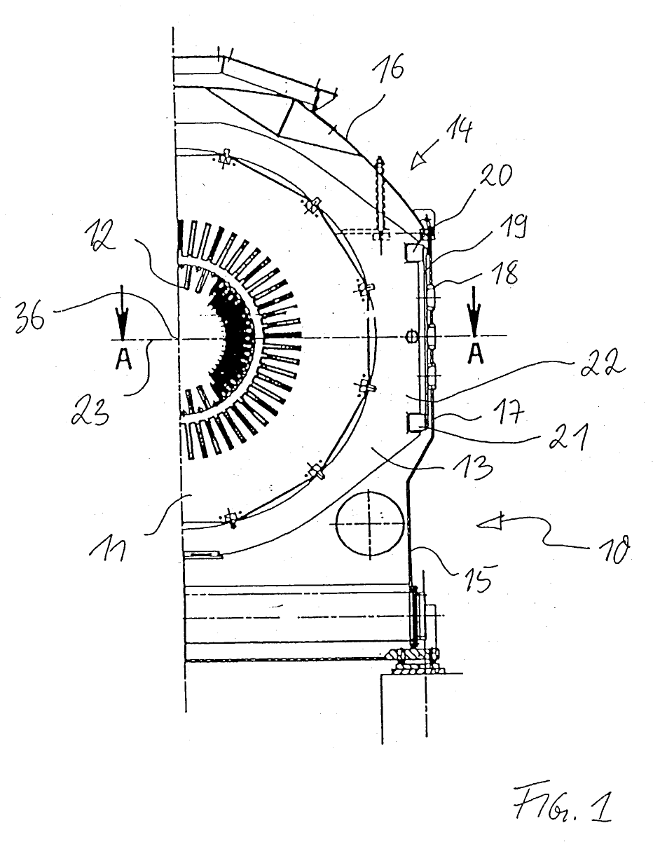

However, it has been found that, in the case of large machines, vibrational isolation between the laminated stator core and the casing would be desirable in order to reduce noise emissions and reliably avoid excessive mechanical stresses of the connecting points between the laminated stator core and the bottom casing section. Such isolation is achieved according to the initially cited EP-A2-0 633 643 in a simple and cost-effective way by the fastening plates arranged between the bearing rings and the bottom casing section being connected to the bearing rings and the bottom casing section in such a way that they act as leaf springs. Such a resilient suspension of the laminated stator core in the casing is reproduced in FIG. 1. FIG. 1 shows in a simplified half-side cross section a horizontal-axis electrical machine 10, which comprises concentrically in relation to a longitudinal axis 36 of the machine a rotor 12 and a laminated stator core 11 surrounding the rotor 12. The rotor 12 and the laminated stator core 11 are accommodated in a casing 14, which is subdivided along a horizontal center plane 23 into a bottom casing section 15 and a top casing section 16. The top casing section 16 can be removed from the bottom casing section 15 for assembly and/or maintenance purposes.

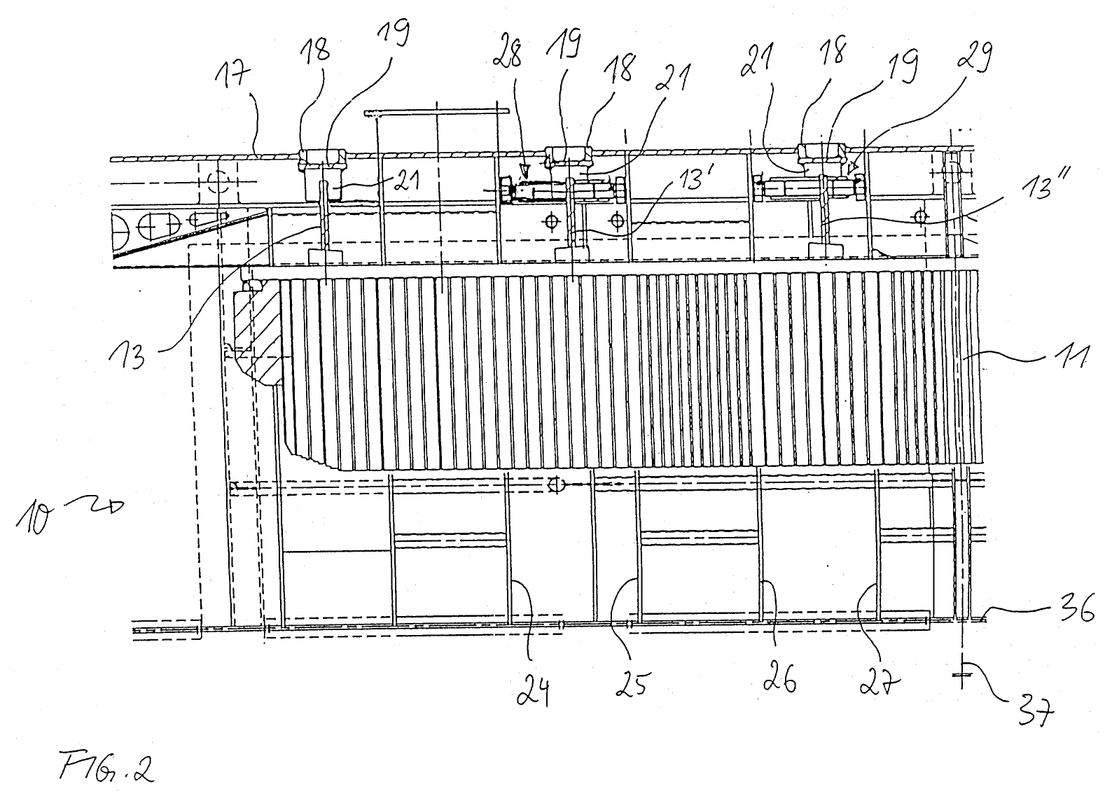

The laminated stator core 11 is—as already described in U.S. Pat. No. 4,663,553 or in EP-A2-0 633 643—fastened in a wedged manner in a multiplicity of bearing rings 13 (13, 13′, 13″ in FIG. 2) arranged one behind the other in the longitudinal axis 36 of the machine. The bearing rings 13 have widenings 22, which protrude laterally on opposite sides and at which they are resiliently connected to the bottom casing section 15. For this purpose, at the upper and lower ends of each widening 22 there are respectively welded on laterally projecting fastening blocks 20, 21, at which for their part a fastening plate 19 acting as a leaf spring is externally welded onto the ends. The fastening plate 19 is welded in its middle region via a plurality of pieces of tube 18, arranged one above the other, to a vertical, planar casing portion 17 of the bottom casing section 15. This type of fastening is represented in FIG. 2 in longitudinal section along the plane A-A from FIG. 1.

Since the laminated stator core 11 has in comparison with the casing 14 a comparatively large mass, considerable acceleration forces can occur between the laminated stator core 11 and the casing 14 during transportation of the machine 10 from its place of production to the place of use, subjecting the resilient fastening and, in particular, the welds provided there to high mechanical stresses. To avoid stresses of this kind during transportation, or at least reduce them to a harmless level, so-called transport arresting screwed joints 28, 29 are used—as shown in FIG. 2. These transport arresting screwed joints are essentially adjustable supporting elements which support the bearing rings 13′, 13″ against neighboring casing ribs 24, 25 and 26, 27, respectively, of the bottom casing section 15 during transportation. For this purpose, threaded sleeves, into which corresponding screws are screwed at the free end, are welded on parallel to the principal axis 36 of the machine on both sides of the bearing ring. When the laminated stator core 11 is inserted into the bottom casing section 15 during pre-assembly at the factory, the screws are initially screwed into the threaded sleeves sufficiently far not to be in the way. Once the bearing rings 13, 13′ and 13″ have been welded to the bottom casing section 15, the screws of the transport arresting screwed joints 28, 29 are unscrewed until they butt with the upper side of the screw head against the neighboring casing rib, as represented in FIG. 2. The laminated stator core 11 is then securely braced in the bottom casing section 15. When there is an axial acceleration of the laminated stator core 11 in relation to the casing 14 during transportation, the acceleration forces occurring can thus be introduced reliably into the casing ribs 24, . . . , 27, without exerting any load on the resilient suspension.

However, it is disadvantageous here that, after the machine 10 has been set up and before it is put into operation, the transport arresting screwed joints have to be unscrewed or loosened, so that a clearance of, for example, 20 mm is created between the screws and the casing ribs 24, . . . , 27 in order that the laminated stator core 11 can freely expand in relation to the housing when the operationally related heating occurs. This is of no consequence if the machine is sent to the place where it is to be set up without a top casing section 16 and with a special transport cover, because unscrewing of the transport arresting screwed joints before fitting of the top casing section 16 is possible without any great additional effort. If, on the other hand, the machine 10 is sent in the complete casing 14 without a transport cover, the top casing section 16 first has to be disassembled at the place of use in the plant in order to loosen the transport arresting screwed joints. This is followed by re-fitting of the top casing section. This procedure is cost-intensive and time-consuming.

It is therefore the object of the invention to provide a machine of the type stated at the beginning in which secure transportation is ensured with regard to the acceleration forces and their effects on the resilient mounting of the laminated stator core, without any transport securing means having to be unscrewed at the place where the machine is set up.

The object is achieved by the overall combination of features of claim 1. The essence of the invention is to limit the relative movement between the laminated stator core and the bottom casing section by suitable means in such a way that, on the one hand, excessive movements or acceleration forces are absorbed during transportation and, on the other hand, the operationally related thermal expansions of the laminated stator core are not hindered.

A first preferred embodiment of the machine according to the invention is characterized in that the casing ribs run parallel to the bearing rings, in that the securing means are respectively arranged between a bearing ring and a neighboring casing rib, and in that the securing means are designed as spacers which extend between the respective bearing ring and the neighboring casing rib, and which are connected by one end securely to the bearing ring or the neighboring casing rib and have a clearance between the other end and the neighboring casing rib or the bearing ring. A suitably chosen clearance can allow the movement during transportation to be effectively limited, without hindering the thermal expansion during later operation.

It is particularly simple if the spacers are designed such that they are adjustable in their length, because then the spacers can be adapted flexibly to the various applications during their fitting. The spacers preferably comprise in each case a threaded sleeve and a screw screwed into the threaded sleeve.

Allowance can be made for the thermal expansion during operation, increasing toward the outer ends of the laminated stator core, by providing that—if the laminated stator core extends on both sides of a vertical center plane oriented perpendicular to the longitudinal axis of the machine—the spacers for the bearing rings further away from the vertical center plane are respectively arranged only between the bearing ring and the neighboring casing rib lying closer to the vertical center plane, while the spacers for the bearing rings lying closer to the vertical center plane are respectively arranged between the bearing ring and the two neighboring casing ribs.

Further embodiments emerge from the dependent claims.

The invention is to be explained in more detail below on the basis of exemplary embodiments in conjunction with the drawing, in which:

FIG. 1 shows in a simplified half-side cross section a horizontal-axis electrical machine with resilient fastening of the laminated stator core in the casing, as to be considered for the implementation of the invention;

FIG. 2 shows in a simplified longitudinal section in the plane A-A from FIG. 1 the machine according to FIG. 1 with a transport arresting screwed joint used until now; and

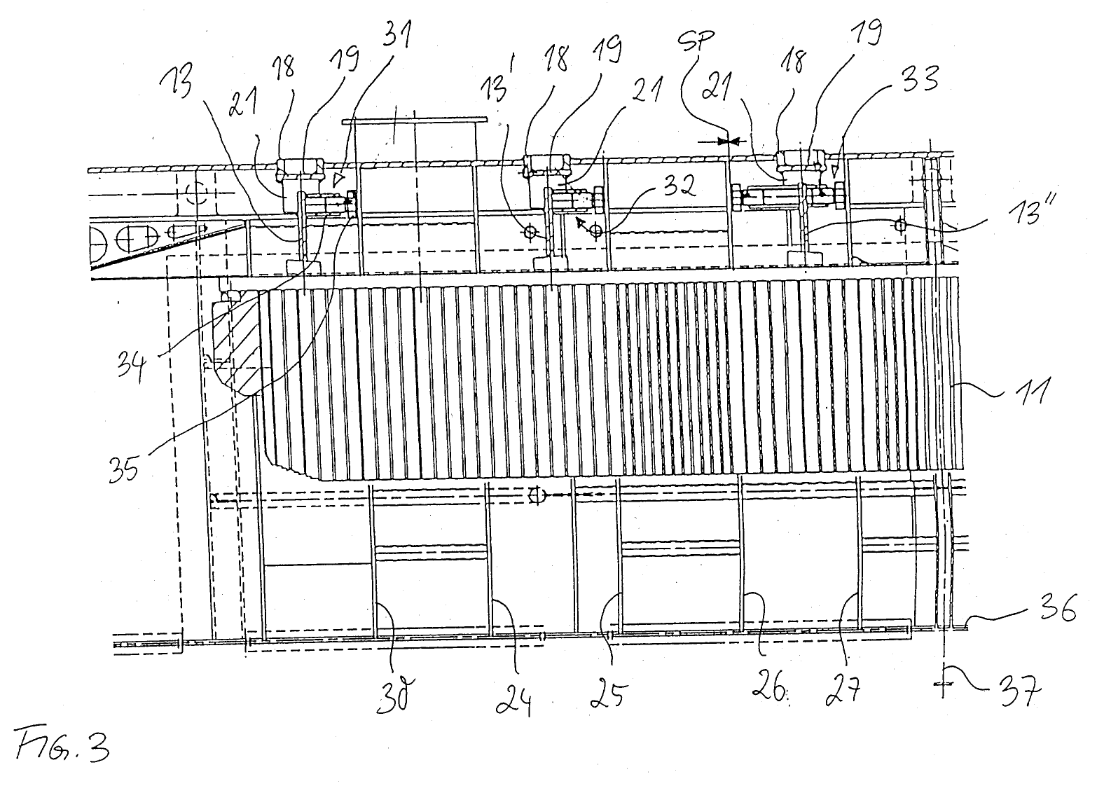

FIG. 3 shows a representation comparable with FIG. 2, with transport securing means according to a preferred exemplary embodiment of the invention.

The invention, as represented in FIG. 3 by way of example, now uses instead of the previous transport arresting screwed joints, which have to be tightened for transportation and subsequently laboriously loosened again, fixedly adjusted spacers 31 . . . , 33. Although the spacers 31, . . . , 33 are of a structurally identical design to the transport arresting screwed joints 28, 29 of FIG. 2, they differ significantly with respect to arrangement and function. The spacers 31, . . . , 33 in each case comprise threaded sleeves 34, which are welded at one end to one of the bearing rings 13, 13′ and 13″, and screws 35, which are screwed into the free end of the threaded sleeves 34 and then fixed.

The spacers 31, . . . , 33 are respectively attached to the edge of the horizontal widening 22 of the bearing rings 13, . . . , 13″ such that they lie in the horizontal center plane 23. The screws 35 are all screwed into the threaded sleeves 34 to the extent that there is a clearance SP of just a few millimeters between the upper sides of the screw heads and the adjacent casing rib 30 or 25, . . . , 27. This clearance SP remains unchanged during and after the transportation of the machine 10 and only changes when the laminated stator core thermally expands during operation.

Since, during the operationally related thermal expansion of the laminated stator core 11, the relative movement between the laminated stator core 11 and the bottom casing section 15 is all the greater the further the location on the laminated stator core 11 is away from the vertical center plane 37, and in the vertical center plane 37 itself tends toward zero, the design and arrangement of the spacers 31, . . . , 33 change with the distance from the vertical center plane 37 of the laminated stator core 11. For the bearing rings 13, 13′ further away from the vertical center plane 37, the spacers 31, 32 are respectively arranged only on one side between the bearing ring and the neighboring casing rib 30 or 25 lying closer to the vertical center plane 37. On the right-hand side (not represented in FIG. 3) of the vertical center plane 37, the arrangement is correspondingly mirror-inverted.

In this way, the transportationally related relative movement, which is uniform for the entire laminated stator core 11, can be reliably limited in both possible axial directions. If the laminated stator core 11 moves to the left in FIG. 3, the outer spacers to the right of the center plane 37 limit the movement. If, on the other hand, the laminated stator core 11 moves to the right, the outer spacers 31, 32 to the left of the center plane 37 limit the movement. The operationally related thermal relative movement, which is directed outward in opposite directions on both sides of the center plane 37, on the other hand, is not hindered by the outer spacers 31, 32, because their clearance increases. For the bearing rings 13″ lying closer to the vertical center plane 37, for which the thermally related relative movement is likely to be small, the spacers 33 may be respectively arranged in opposite directions between the bearing ring and the two neighboring casing ribs 26, 27. During operation, the clearance SP between the spacer 33 and the casing ribs 26, 27 then increases on the right-hand side of the bearing ring 13″, while it decreases on the left-hand side, without however becoming zero.

Altogether, acceleration forces of up to 1 g can be reliably absorbed and dissipated in this way without changing the spacers 31, . . . , 33 during transportation of the machine 10, while during later operation the laminated stator core 11, being warmer than the casing 14, can freely expand.

List of Designations

10 electrical machine (horizontal-axis)

11 laminated stator core

12 rotor

13, 13′, 13″ bearing ring

14 casing

15 bottom casing section

16 top casing section

17 casing portion (vertical, planar)

18 piece of tube

19 fastening plate

20, 21 fastening block

22 widening (horizontal)

23 center plane (horizontal)

24, . . . , 27, 30 casing rib

28, 29 transport arresting screwed joints

31, . . . , 33 spacers

34 threaded sleeve

35 screw

36 longitudinal axis of machine

37 center plane (vertical)

SP clearance

1. A horizontal-axis electrical machine (10), comprising a casing (14, 15, 16), which is reinforced by casing ribs (24, . . . , 27, 30) and is subdivided into a bottom casing section (15) and a removable top casing section (16), and comprising a laminated stator core (11), which is braced in bearing rings (13, 13′, 13″), which are arranged perpendicular to the longitudinal axis (36) of the machine, are spaced apart from one another and are resiliently connected at a plurality of points of their outer circumference to the bottom casing section (15) by means of fastening parts (18, 19, 20, 21), characterized in that between the laminated stator core (11) or the bearing rings (13, 13′, 13″) and the bottom casing section (15) there are arranged fixedly adjusted securing means (31, . . . , 35), which during transportation of the machine (10) limit the axial relative movement between the laminated stator core (11) or the bearing rings (13, 13′, 13″) and the bottom casing section (15), and during operation ensure a free expansion of the warmer laminated stator core (11) with respect to the colder casing (14, 15, 16).

2. The machine as claimed in claim 1, characterized in that the casing ribs (24, . . . , 27, 30) run parallel to the bearing rings (13, 13′, 13″), and in that the securing means (31, . . . , 35) are respectively arranged between a bearing ring (13, 13′, 13″) and a neighboring casing rib (24, . . . , 27, 30).

3. The machine as claimed in claim 2, characterized in that the securing means are designed as spacers (31, . . . , 33) which extend between the respective bearing ring and the neighbouring casing rib, and which are connected by one end securely to the bearing ring or the neighboring casing rib and have a clearance (SP) between the other end and the neighboring casing rib or the bearing ring.

4. The machine as claimed in claim 3, characterized in that the spacers (31, . . . , 33) are designed such that they are adjustable in their length.

5. The machine as claimed in claim 4, characterized in that the spacers (31, . . . , 33) comprise in each case a threaded sleeve (34) and a screw (35) screwed into the threaded sleeve (34).

6. The machine as claimed in one of claims 3 to 5, characterized in that the laminated stator core (11) extends on both sides of a vertical center plane (37) oriented perpendicular to the longitudinal axis (36) of the machine, and in that the spacers (31, 32) for the bearing rings (13, 13′) further away from the vertical center plane (37) are respectively arranged only between the bearing ring and the neighboring casing rib (30 or 25) lying closer to the vertical center plane (37).

7. The machine as claimed in claim 6, characterized in that the spacers (33) for the bearing rings (13″) lying closer to the vertical center plane (37) are respectively arranged between the bearing ring and the two neighboring casing ribs (26, 27).

8. The machine as claimed in one of claims 1 to 7, characterized in that the fastening parts comprise elongate fastening plates (19) which act as leaf springs, are vertically arranged and are securely connected, in particular welded, in each case in the middle region to the bottom casing section (15) and at the ends to the bearing rings (13, 13′, 13″).
